(19) United States
(12) Patent Application Publication
(10) Pub. No.: US 2024/0246503 A1
(43) Pub. Date: Jul. 25, 2024

(54) VEHICLE INSIDE VIEW MONITOR

(71) Applicant: DENSO CORPORATION, Kariya-city (JP)

(72) Inventors: Yuki DATE, Kariya-city (JP); Ryosuke OGURI, Kariya-city (JP); Yoshiki MATSUSHITA, Kariya-city (JP)

(73) Assignee: DENSO CORPORATION, Kariya-city (JP)

(21) Appl. No.: 18/585,253

(22) Filed: Feb. 23, 2024

Related U.S. Application Data
(63) Continuation of application No. PCT/JP22/31135, filed on Aug. 17, 2022.

(30) Foreign Application Priority Data
Aug. 23, 2021 (JP) 2021-135370

(51) Int. Cl. B60R 21/015; B60L 58/12

(52) U.S. Cl. CPC B60R 21/01542; B60L 58/12; B60R 21/0153

(57) ABSTRACT

A vehicle inside view monitor monitors inside view of passenger compartment of vehicle which is parked. Vehicle inside view monitor includes living object sensor, environment determiner, environment improvement unit, and state-of-charge determiner. Living object sensor works detecting living object left in passenger compartment. When living object is detected, environment determiner determines whether deterioration condition of passenger compartment which is unsuitable for living object has occurred. When determined that deterioration condition of passenger compartment has occurred, environment improvement unit actuates at least one of a high-power improvement device and a low-power improvement device. State-of-charge determiner determines whether a state of charge of battery has reduced. When determined that deterioration condition of passenger compartment has occurred, environment improvement unit actuates high-power improvement device unless state of charge of battery is determined to have decreased and alternatively actuates only low-power improvement device when state of charge of battery is determined to have decreased.

### CROSS REFERENCE TO RELATED DOCUMENT

The present application claims the benefit of priority of Japanese Patent Application No. 2021-135370 filed on Aug. 23, 2021, the disclosure of which is incorporated in its entirety herein by reference.

### TECHNICAL FIELD

This disclosure relates generally to a vehicle inside view monitor.

### BACKGROUND OF ART

Patent literature 1 discloses a vehicle inside view monitor which works to monitor a passenger compartment of a vehicle parked. When detecting a living object left inside the passenger compartment and a deterioration of condition of the passenger compartment unsuitable for the living object, the vehicle inside view monitor instructs, for example, an air-conditioner ECU to control the temperature in the passenger compartment using an air-conditioner. Additionally, when a decrease occurs in amount of electrical energy stored in a battery, the vehicle inside view monitor also works to request another vehicle parked around the subject vehicle to transfer electrical energy to the subject vehicle in a wireless mode to secure a required amount of electricity.

### PRIOR ART DOCUMENT

### Patent Literature

PATENT LITERATURE 1: Japanese Patent First Publication No. 2020-128124

### SUMMARY OF THE INVENTION

The above vehicle inside view monitor is designed not to always receive electrical power in response to a request from a power transfer request unit, thus leading to a risk that the air-conditioner ECU may continue to control the temperature in the passenger compartment using the air-conditioner although the amount of electrical energy stored in the battery is low, thereby resulting in the battery promptly becoming empty. This may result in various failures in control operations performed subsequently.

It is an object of this disclosure to provide a vehicle inside view monitor designed to maximize improvement of environments in a passenger compartment of a vehicle with a minimized risk that a stage of charge in a storage battery may become empty early.

According to one aspect of this disclosure, there is provided a vehicle inside view monitor which monitors an inside view of a passenger compartment of a vehicle which is parked. The vehicle inside view monitor comprises: (a) a living object sensor which detects a living object left in the passenger compartment; (b) an environment determiner which, when the living object left in the passenger compartment is detected, determines whether a deterioration in condition of the passenger compartment unsuitable for the living object has occurred; (c) an environment improvement unit which, when the deterioration in condition of the passenger compartment is determined to have occurred, actuates at least one of a high-power improvement device and a low-power improvement device mounted in the vehicle as one of improvement strategies for improving the condition of the passenger compartment; and (d) a state-of-charge determiner which determines whether a state of charge of a battery has decreased. When the deterioration of condition of the passenger compartment is determined to have occurred, the environment improvement unit works to actuate the high-power improvement device unless the state of charge of the battery is determined to have decreased and alternatively actuate only the low-power improvement device when the state of charge of the battery is determined to have decreased undesirably.

When it is determined that the condition of the passenger compartment of the vehicle has deteriorated, the high-power improvement device is, as described above, actuated unless the state of charge of the battery is determined to have deteriorated, thereby resulting in a major improvement of the condition of the passenger compartment. When it is determined that the condition of the passenger compartment of the vehicle has deteriorate and that the state of charge of the battery is lowered, only the low-power improvement device is actuated, thereby improving the condition of the passenger compartment with a decrease in the state of charge of the battery being minimized. It is, therefore, possible to increase the condition of the passenger compartment as greatly as possible while minimizing the consumption of electrical energy stored in the battery.

### BRIEF DESCRIPTION OF THE DRAWINGS

The above object, other objects, features, and advantages of or offered by this disclosure will be understood more fully from the detailed description given hereinbelow and from the accompanying drawings.

In the drawings:

FIG. 1 is a block diagram which illustrates a system including a vehicle inside view monitor according to an embodiment;

FIG. 2 is a flowchart which illustrates an example of a task performed by a vehicle inside view monitor ECU in an embodiment;

FIG. 3 is a flowchart which illustrates an example of a task performed by a vehicle inside view monitor ECU in an embodiment;

FIG. 4 is a flowchart which illustrates an example of a task performed by a vehicle inside view monitor ECU in an embodiment;

FIG. 5 is a flowchart which illustrates an example of a task performed by a vehicle inside view monitor ECU in an embodiment; and

FIG. 6 is a flowchart which illustrates an example of a task performed by a vehicle inside view monitor ECU in an embodiment.

### EMBODIMENT FOR CARRYING OUT THE INVENTION

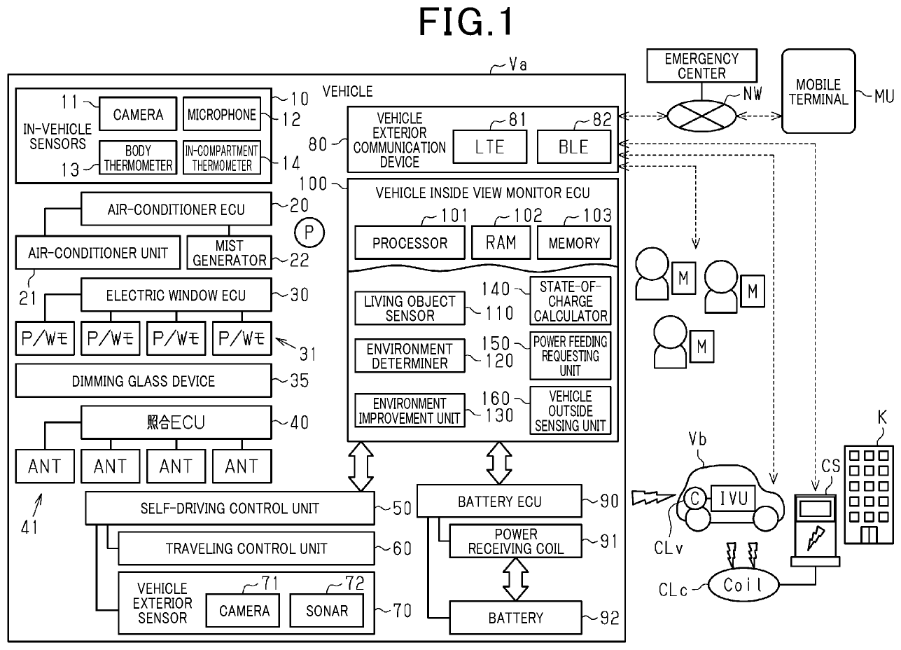

A vehicle inside view monitor according to the first embodiment will be described below with reference to FIGS. 1 to 6. The vehicle inside view monitor is implemented by the vehicle inside view monitor ECU 100 that is a computer installed in the vehicle Va. The vehicle inside view monitor ECU 100 is designed to monitor the inside of a passenger compartment of the parked vehicle Va, especially to monitor a condition of a living object P, such as a dog, a cat, or a baby left inside the passenger compartment. The vehicle Va, as referred to herein, is an electrical vehicle equipped with an electrical motor working as a traction power source. The vehicle Va may also be a self-driving vehicle which operates in an autonomous mode without need for operations by the driver.

The vehicle inside view monitor ECU 100 is connected to various vehicle-mounted devices, such as the in-vehicle sensors 10, the air-conditioner ECU 20, the electric window ECU 30, the dimming glass device 35, and the identification ECU 40 through an in-vehicle network in an interactive communication mode. The vehicle inside view monitor ECU 100 is also connected to vehicle-mounted devices, such as the self-driving control unit 50, the vehicle exterior communication devices 80, and the battery ECU 90 through the in-vehicle network in an interactive communication mode. Each ECU and each control unit are mainly made of a microcomputer including a processor, a RAM, a memory, an input-output interface, and buses connecting them.

The in-vehicle sensors 10 are sensors which derive given parameters related to conditions in the passenger compartment of the vehicle Va and outputs them in the form of monitored in-vehicle condition information. Specifically, the in-vehicle sensors 10 include the in-vehicle camera 11, the microphone 12, the body thermometer 13, and the in-compartment thermometer 14. The in-vehicle camera 11 works to capture an image of the inside of the passenger compartment and sequentially outputs it in the form of image data to the vehicle inside view monitor ECU 100. The microphone 12 detects sound in the passenger compartment and sequentially outputs it to the vehicle inside view monitor ECU 100. The body thermometer 13 measures the temperature of a living object present inside the passenger compartment and sequentially outputs it to the vehicle inside view monitor ECU 100. The body thermometer 13 may be implemented by a contact sensor attached to the living object or a non-contact sensor, such as a thermographic camera. The in-compartment thermometer 14 measures the temperature of air in the passenger compartment and sequentially outputs it to the vehicle inside view monitor ECU 100. The in-vehicle sensors may also include a CO sensor working to measure the concentration of carbon monoxide and/or a seat sensor working to detect the presence or absence of an occupant on the seat of the vehicle Va.

The air-conditioner ECU 20 works to control operations of the air-conditioner unit 21 and the mist generator 22. The air-conditioner unit 21 is equipped with a fan and a heat pump cycle system working to control the temperature of a flow of air created by the fan. The air-conditioner unit 21 works to emit temperature-conditioned air from a plurality of air vents opening at some places inside the passenger compartment. The air-conditioner unit 21 is capable of controlling the flow rate of air from each of the air vents using a damper. The mist generator 22 is a device creating and emitting a spray of water into the passenger compartment. The vehicle Va may also be equipped with another type of air conditioner, such as a seat-air conditioning system operating to jet air from the seats in the passenger compartment. The air-conditioner ECU 20 may be also designed to control the operation of the above additional air conditioner.

The electric window ECU 30 is a controller to open or close side windows installed in doors of the vehicle Va. The electric window ECU 30 is connected to the power window motors 31 installed in the doors through signal lines. The electric window ECU 30 is capable of individually controlling operations of the power window motors 31 to regulate the degree to which each of the side windows is opened. A system including the electric window ECU 30 and the power window motors 31 is equipped with an anti-pinch window system and an anti-trap window system to avoid pinching or trapping when the side windows are opened or closed.

The dimming glass device 3 includes a diming glass ECU to switch between a transparent or opaque state of at least one of the front window, the side windows, the rear window, and the roof glass of the vehicle Va using an electrical signal.

The identification ECU 40 is a controller which works to analyze a signal outputted from an external transmitter, such as an electronic key, to identify the transmitter. When properly identifying the transmitter, the identification ECU 40 permits an vehicle-mounted device to unlock the doors of the vehicle Va. Specifically, the identification ECU 40 is electrically connected to a plurality of antennas 41 built in door handles of the vehicle Va. The identification ECU 40 is responsive to a signal which is outputted from the transmitter and received by one of the antennas 41 to identify the transmitter. The identification ECU is capable of analyzing a difference in intensity among signals received by the antennas 41 to determine whether the transmitter has been removed from the vehicle Va and also calculate a direction in which the transmitter has been moved away from the vehicle Va.

The self-driving control unit 50 is connected to the traveling control unit 60 and the vehicle exterior sensors 70 through communication buses. The self-driving control unit 50 analyzes or uses information derived from the vehicle exterior sensors 70, information about a map, and information about the current position of the vehicle Va to produce a driving strategy for the vehicle Va. The self-driving control unit 50 sequentially outputs control instructions to the vehicle Va according to the driving strategy.

The vehicle exterior sensors 70 are autonomous sensors which monitor environments surrounding the vehicle Va. The vehicle exterior sensors 70 include the exterior camera 71, the sonar 72, a LIDAR, and/or a millimeter-wave radar. The vehicle exterior sensors 70 work to detect moving objects, such as pedestrians or other vehicles, or stationary objects, such as objects arranged on or around the road or lane markings on the road, existing around the vehicle Va, and output results of the detection to the self-driving control unit 50. The vehicle exterior sensors 70 may include a solar radiation sensor measuring the amount of solar radiation and/or a temperature sensor measuring an ambient temperature of the vehicle Va.

The traveling control unit 60 is electrically connected directly or indirectly to a group of vehicle-mounted sensors and a group of vehicle-mounted actuators installed in the vehicle Va. The group of vehicle-mounted sensors includes a plurality of sensors which monitor conditions of the vehicle Va. The group of vehicle-mounted sensors may include a vehicle speed sensor, a vehicle acceleration sensor, and/or a yaw rate sensor. The group of vehicle-mounted actuators are designed to perform control tasks to control acceleration or deceleration of the vehicle Va or driving operations of the vehicle Va. The group of vehicle-mounted actuators may include a motor-generator working to drive the vehicle Va or produce regenerative electric power, a brake actuator, or a steering actuator.

The traveling control unit 60 is made of a vehicle-installed computer mainly equipped with a control circuit including a processor, a RAM, a memory, and an input/output interface. The traveling control unit 60 delivers conditions of the vehicle Va, as measured by the group of vehicle-mounted sensors sequentially to a driving interface unit. The traveling control unit 60 derives control instructions, such as driving, braking, and steering instructions, from the self-driving control unit 50. The traveling control unit 60 analyzes the control instructions derived to operate the group of vehicle-mounted actuators to drive the vehicle Va autonomously according to the driving strategy.

The vehicle exterior communication devices 80 are devices which achieve radio communications between vehicle-mounted devices and external systems. The vehicle exterior communication devices 80 include the LTE communication module 81 and the BLE communication module 82. The LTE communication module 81 has the function of V2N (Vehicle to cellular Network) communication in accordance with an LTE (Long-Term Evolution) communications standard and is communicable in a wireless mode with a communication network NW installed outside the vehicle Va. The communication network NW is connected to, for example, a system in a hospital emergency center. The LTE communication device 81 is wirelessly communicable with a terminal MU carried by a user of the vehicle Va through the communication network NW. The vehicle exterior communication devices 80 may alternatively include a communication module which is capable of wirelessly communicating with the communication network NW in accordance with another communications standard, such as 5G, instead of the LTE communication module 81.

The BLE communication module 82 is a module which achieves communication according to a near field communication standard of Bluetooth Low Energy (Bluetooth is a registered mark). The BLE communication module 82 is capable of intercommunicating with mobile terminals M around the vehicle Va, another parked vehicle Vb, or the charging station CS. The vehicle exterior communication devices 80 may alternatively include a communication module which achieves near field communication according to another standard, such as Wi-Fi (registered mark) or ZigBee (registered mark), instead of the BLE communication module 82.

The battery ECU 90 is electrically connected to the battery 92 and the power receiving coil 91. The battery 92 is electrically connected to the power receiving coil 91 through a relay. The power receiving coil 91 serves to transmit electrical power, as delivered from the power feeding coil CLv of the charging station CS or the power feeding coil CLv of the vehicle Vb, to the battery 92. The battery ECU 90 works to monitor the condition of the battery 92 in the vehicle Va and also control a charging or a discharging operation of the battery 92. When the capacity remaining in the battery 92 becomes lower than a predetermined threshold level, the battery ECU 90 informs the vehicle inside view monitor ECU 100 of a reduction in remaining capacity of the battery 92. When wireless power transmission is available from the vehicle Vb, the battery ECU 90 turns on the relay connecting between the battery 92 and the power receiving coil 91 to start charging the battery 92 in the wireless power transferring mode.

The vehicle inside view monitor ECU 100 is made mainly of a microcomputer including the processor 101, the RAM 102, the memory device 103, and busses electrically connecting them together. The vehicle inside view monitor ECU 100 is electrically connected to a local area network in the vehicle Va. The vehicle inside view monitor ECU 100 executes control programs, as stored in the memory device 103, based on the condition of the vehicle Va to perform control tasks to take measures dealing with a deterioration in environment of the vehicle Va. The memory device 103 is implemented by a non-transitory recording medium which stores computer-readable programs or data. The recording medium is realized by, for example, a semiconductor memory or a magnetic disk.

The vehicle inside view monitor ECU 100 includes, in the form of functional blocks, the living object sensor 110, the environment determiner 120, the environment improvement unit 130, the state-of-charge determiner 140, the power feeding requesting unit 150, and the vehicle outside sensing unit 160 which are realized by executing the above-described control programs.

The living object sensor 110 uses the monitored in-vehicle condition information about several types of parameters derived by the in-vehicle sensors 10 to detect the living object P left inside the passenger compartment of the vehicle Va. Specifically, the living object sensor 110 derives information about the presence or absence of the living object P, the type of the living object P, the current position of the living object P within the passenger compartment, and biological information about the living object P.

The living object sensor 110 is configured to determine the presence or absence of the living object P and the type of the living object P by analyzing data on an image captured by the in-vehicle camera 11 using image recognition techniques. Specifically, the living object sensor 110 identifies the type of the living object P, such as a human being, a dog, or a cat, and also determines classification, such as the type of dog or cat. In a case where a transmitter is attached to the living object P, the living object sensor 110 may analyze a signal outputted from the transmitter to determine the presence or absence of the living object P and the type of the living object P.

The living object sensor 110 determines the current position of the living object P in the passenger compartment of the vehicle Va. Specifically, the living object sensor 110 analyzes, for example, data on an image captured by the in-vehicle camera 11 to determine one of a plurality of regions pre-defined in the passenger compartment where the living object P exists as the current position of the living object P.

The living object sensor 110 derives information about the body temperature measured by the body thermometer 13 as the biological information. In a case where the living object P is a pet animal, the living object sensor 110 analyzes a breath sound of the living object P, as measured by the microphone 12, to determine the condition of health of the living object P as the biological information. For instance, the living object sensor 110 calculates a breathing condition of the living object P, such as a rhythm or depth of breathing thereof, using the breath sound to determine or express a health condition of the living object P in the form of one of a plurality of levels in terms of abnormality of health.

The environment determiner 120 uses the information about parameters derived by the in-vehicle sensors 10 to determine whether a deterioration in condition of the passenger compartment unsuitable for the living object P has occurred. For instance, the environment determiner 120 determines an excessive rise in temperature in the passenger compartment as the deterioration in condition in the passenger compartment. The environment determiner 120 also analyzes the compartment temperature information about the temperature of the passenger compartment measured by the in-compartment thermometer 14 and, when the temperature is higher than a threshold level, determines the condition of the passenger compartment as having deteriorated. When determining that the condition of the passenger compartment is unsuitable for the living object P, the environment determiner 120 determines that the deterioration in condition of the passenger compartment has occurred regardless of whether it has deteriorated more than before. The environment determiner 120 may use the biological information in addition to the compartment temperature information about the temperature of the passenger compartment to determine the deterioration in condition of the passenger compartment.

Additionally, the environment determiner 120 also analyzes the biological information to determine whether the health of the living object P has deteriorated. For instance, when the temperature of the living object P has excessively risen and/or the condition of breathing of the living object P has been undesirably lowered, the environment determiner 120 determines that the health of the living object P has deteriorated. The environment determiner 120 makes such a determination after an improvement task, as will be described later, starts being performed.

When the living object P which is left in the passenger compartment of the parked vehicle Va is detected, and when the environment determiner 120 determines that the condition of the passenger compartment as having deteriorated, the environment improvement unit 130 actuates the vehicle-mounted devices to improve the condition of the passenger compartment using electrical power from the battery 92. Specifically, when the environment determiner 120 determines that the condition of the passenger compartment as having deteriorated, the environment improvement unit 130 actuates, as one of improvement strategies, at least one of a high-power improvement device and a low-power improvement device installed in the vehicle Va in order to improve the condition of the passenger compartment. The high-power improvement device is a device which consumes a large amount of electrical power, but is capable of making a large improvement of the condition of the passenger compartment. The low-power improvement device is a device which is capable of improving the condition of the passenger compartment with a smaller consumption of electrical power than the high-power improvement device. The high-power improvement device in this embodiment includes the air-conditioner unit 21, while the low-power improvement device in this embodiment includes the power window motors 31. Specifically, when the environment determiner 120 determines that the condition of the passenger compartment as having deteriorated, the environment improvement unit 130 actuates at least one of the air-conditioner unit 21 and the power window motors 31 according to conditions which will be described later in detail. When the vehicle Va is parked, and when the identification ECU 40 determines that the transmitter, such as an electronic key, has moved away from the vehicle Va before the living object P starts being detected, the environment improvement unit 130 actuates the power window motors 31 to close all the side windows of the vehicle Va.

The environment improvement unit 130 may perform another improvement strategy to, for example, instruct the self-driving control unit 50 to move the vehicle Va to a shady area in an autonomous mode. The determination of the shady area may be made by the self-driving control unit 50 using the information on parameters detected by the vehicle exterior sensors 70, the map information, and/or information about the position or orientation of the sun.

The environment improvement unit 130 may instruct, as one of the improvement strategies, the self-driving control unit 50 to move the vehicle Va to an area where the charging station CS is installed, and it is possible for the charging station CS to transfer electrical power to the vehicle Va in the wireless mode. The environment improvement unit 130 derives the information about the location where the charging station CS is installed through communication with the charging station CS through the vehicle exterior communication devices 80. The adjustment of the position of the vehicle Va to where the electrical power is available from the charging station CS may be achieved by the self-driving control unit 50 using recognition of an image captured by the exterior camera 71.

The environment improvement unit 130 may actuate, as one of the improvement strategies, the mist generator 22. Additionally, the environment improvement unit 130 may also actuate, as one of the improvement strategies, the seat-air conditioning system to jet air from the seats in the passenger compartment.

The state-of-charge determiner 140 serves to determine whether the amount of electrical energy remaining in the battery 92 has decreased. Specifically, the state-of-charge determiner 140 determines whether the state of charge of the battery 92 has decreased based on the presence or absence of the information about the reduction in state of charge of the battery 92 from the battery ECU 90. When it is determined that the deterioration of condition of the passenger compartment has occurred, and that the state of charge of the battery 92 has reduced, the power feeding requesting unit 150 requests the vehicle-mounted device IVU installed in the vehicle Vb parked near the vehicle Va to transfer electrical power to the vehicle Va in the wireless mode. When the request is permitted, the power feeding requesting unit 150 instructs the vehicle Va to a location where it is possible to receive the electrical power from the vehicle-mounted device IVU in the wireless mode. When it becomes possible to receive the electrical power from the vehicle-mounted device IVU in the wireless mode, the power feeding requesting unit 150 instructs the battery ECU 90 to start receiving the electrical power from the vehicle-mounted device IVU.

The vehicle outside sensing unit 160 analyzes the parameters detected by the vehicle exterior sensors 70 to derive information about a person around the vehicle Va. The vehicle outside sensing unit 160 determines whether the person detected around the vehicle Va meets a preregistered deselection condition where it is unnecessary to pay attention thereto. Specifically, the vehicle outside sensing unit 160 communicates with the mobile terminal M carried by the detected person through the BLE communication module 82 to determine whether the mobile terminal M is identified as a preregistered authorized one. When an affirmative answer is obtained, the vehicle outside sensing unit 160 determines that the detected person meets the preregistered deselection condition.

When it is determined that the condition of the passenger compartment has deteriorated, the environment improvement unit 130 also actuates the air-conditioner unit 21 unless the state of charge of the battery 92 is determined as having undesirably decreased. Alternatively, when the state of charge of the battery 92 is determined as having undesirably decreased, the environment improvement unit 130 actuates only the power window motors 31.

More specifically, when it is determined that the condition of the passenger compartment has deteriorated and that the state of charge of the battery 92 is determined not to have undesirably decreased, the environment improvement unit 130 instructs the air-conditioner ECU 20 and the electric window ECU to actuate the air-conditioner unit 21 and the power window motors 31. In other words, when it is determined that the condition of the passenger compartment has deteriorated, the environment improvement unit 130 supplies temperature-conditioned air to the passenger compartment and also opens the side windows of the vehicle Va unless the state of charge of the battery 92 is determined as having undesirably decreased.

When it is determined that the condition of the passenger compartment has deteriorated and that the state of charge of the battery 92 is determined to have undesirably decreased, the environment improvement unit 130 instructs the electric window ECU 30 to turn on the power window motors 31 without actuating the air-conditioner unit 21. In other words, when it is determined that the condition of the passenger compartment has deteriorated and that the state of charge of the battery 92 is determined as having undesirably decreased, the environment improvement unit 130 only opens the side windows of the vehicle Va as long as the state of charge of the battery 92 is determined as having undesirably decreased.

When it is determined that the condition of the passenger compartment has deteriorated and that the state of charge of the battery 92 is determined to have undesirably decreased, but when the reception of electrical power becomes available for the vehicle Va in response to a request made by the power feeding requesting unit 150, the environment improvement unit 130 actuates the air-conditioner unit 21. For instance, when it is determined that the condition of the passenger compartment has deteriorated and that the state of charge of the battery 92 is determined to have undesirably decreased, but when it is determined that the vehicle Va will start receiving electrical power within a predetermined period of time in response to a request made by the power feeding requesting unit 150, the environment improvement unit 130 actuates the air-conditioner unit 21. When the request made by the power feeding requesting unit 150 is denied or when a period of time between when the request is made by the power feeding requesting unit 150 and when the reception of electrical power is expected to start is determined to exceed a predetermined time, the environment improvement unit 130 does not turn on the air-conditioner unit 21.

When it is determined that the condition of the passenger compartment has deteriorated and that a person is detected near the vehicle Va, the environment improvement unit 130 controls the degree to which the side windows are opened to be smaller than when no person is detected near the vehicle Va. For instance, when it is determined that the condition of the passenger compartment has deteriorated and that no person is detected near the vehicle Va, the environment improvement unit 130 fully opens the side windows. Alternatively, when it is determined that the condition of the passenger compartment has deteriorated and that a person is detected near the vehicle Va, the environment improvement unit 130 opens the side windows only by, for example, 1 cm.

Additionally, when the person detected near the vehicle Va meets the above-described deselection condition, the environment improvement unit 130 controls the degree to which the side windows are opened to be larger than when no persons which meet the deselection condition are detected. For instance, when a person which meets the deselection condition is detected near the vehicle Va, the environment improvement unit 130 fully opens the side windows. Alternatively, when no persons which meet the deselected condition are detected, the environment improvement unit 130 opens the side windows only by 1 cm.

Additionally, when a person is detected near the vehicle Va, the environment improvement unit 130 also opens one of the side windows which is closest to the current position of the living object P to a degree smaller than one of the side windows which is far away from the living object P. For instance, when a person is detected near the vehicle Va and when the living object P is on the front passenger's seat, the environment improvement unit 130 fully opens the side window for the front passenger's seat and also opens the other side windows by 1 cm.

When it is determined that the condition of the passenger compartment has deteriorated and that a person is detected near the vehicle Va, the environment improvement unit 130 performs the above-described improvement strategy and then monitors the current position of the living object P. When the living object P is found to have moved while it is being monitored, the environment improvement unit 130 changes the degree to which one of the side windows which is closest to the changed position of the living object P to be smaller than at least one of the side windows which is located farther away from the changed position of the living object P. For instance, when the living object P is detected to have moved from the front passenger's seat to the driver's seat, the environment improvement unit 130 fully closes the side window for the driver's seat and opens the other side windows only by 1 cm.

When the above-described improvement strategy is performed after which it is determined that the health of the living object P has deteriorated, the environment improvement unit 130 moves the vehicle Va to the emergency place K, such as a hospital or a police station in the autonomous mode. Specifically, when the health of the living object P is determined as having deteriorated after the above-described improvement strategy is performed, the environment improvement unit 130 instructs the self-driving control unit 50 to move the vehicle Va to the emergency place K in the autonomous mode.

When the living object P left inside the passenger compartment is detected, the environment improvement unit 130 actuates the dimming glass device 3 to set the windows of the vehicle Va in the opaque state regardless of whether the condition of the passenger compartment has deteriorated.

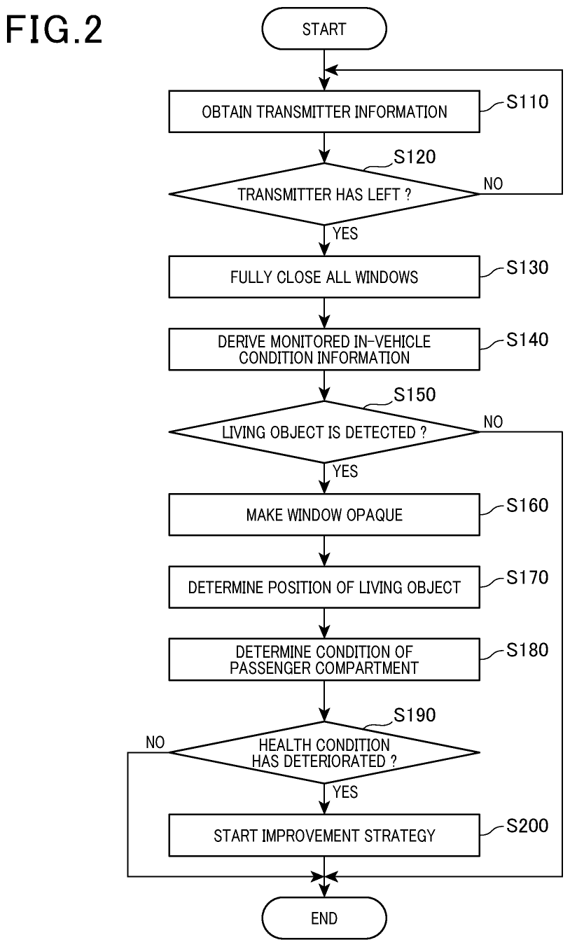

An example of tasks performed by parts of the vehicle inside view monitor ECU 100 will be described below with reference to flowcharts of FIGS. 2 to 6. In the program illustrated in FIG. 2, the vehicle inside view monitor ECU 100 determines whether the improvement strategies should be started. For instance, such as task starts being initiated at a time when the vehicle Va is parked or a given period of time after the vehicle Va is parked. The task in FIG. 2 may be performed cyclically while the vehicle Va is being parked.

After entering the program of FIG. 2, the routine proceeds to step S110 wherein the vehicle inside view monitor ECU 100 derives transmitter information about the transmitter M detected by the identification ECU 40. The routine then proceeds to step S120. The transmitter information includes information indicating whether the transmitter, such as an electronic key, has left away from the vehicle Va. In step S120, the vehicle inside view monitor ECU 100 determines whether the transmitter has left away from the vehicle Va. If a NO answer is obtained meaning that the transmitter still remains near the vehicle Va, the routine returns back to step S110. Alternatively, if a YES answer is obtained meaning that the transmitter has left away from the vehicle Va, then the routine proceeds to step S130 wherein the vehicle inside view monitor ECU 100 outputs a control signal to the electric window ECU 30 to actuate the power window motors 31 to fully close all the side windows of the vehicle Va. The routine then proceeds to step S140.

In step S140, the vehicle inside view monitor ECU 100 derives the monitored in-vehicle condition information obtained by the in-vehicle sensors 10. The routine proceeds to step S150 wherein the vehicle inside view monitor ECU 100 analyzes the monitored in-vehicle condition information to determine whether the living object P is detected inside the passenger compartment. If a NO answer is obtained meaning that no living object is detected and that there is no need to perform the improvement strategies, then the routine terminates.

Alternatively, if a YES answer is obtained in step S150 meaning that the vehicle inside view monitor ECU 100 determines that the living object P is detected, then the routine proceeds to step S160 wherein the vehicle inside view monitor ECU 100 actuates the dimming glass device 3 to set at least one of the front window, the side windows, the rear window, and the roof glass in the opaque state. For instance, the vehicle inside view monitor ECU 100 sets all the windows of the vehicle Va in the opaque state. The routine then proceeds to step S170.

In step S170, the vehicle inside view monitor ECU 100 analyzes the monitored in-vehicle condition information to determine the type and the current position of the living object P. The routine proceeds to step S180 wherein the vehicle inside view monitor ECU 100 determines the condition of the passenger compartment using the compartment temperature information. The routine then proceeds to step S190 wherein the vehicle inside view monitor ECU 100 determines whether the condition of the passenger compartment t has deteriorated using the compartment condition derived in step S180. If a NO answer is obtained meaning that the condition of the passenger compartment remains unchanged, then the routine terminates.

Alternatively, if a YES answer is obtained in step S190 meaning that the condition of the passenger compartment has deteriorated, then the routine proceeds to step S200 wherein the vehicle inside view monitor ECU 100 starts performing the improvement strategies, as will be described later in detail. The routine then terminates.

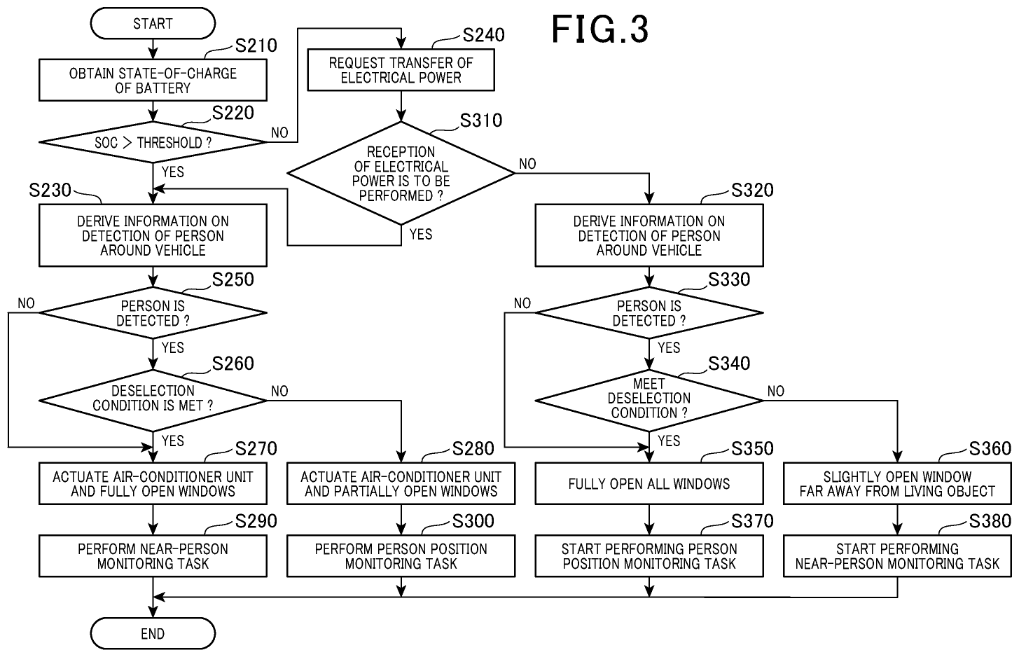

The vehicle inside view monitor ECU 100 performs the improvement strategies in the way demonstrated in FIG. 3. First, in step S210, the vehicle inside view monitor ECU 100 derives information about the state of charge of the battery 92. The routine proceeds to step S220 wherein the vehicle inside view monitor ECU 100 determines whether the state of charge of the battery 92 is higher than a threshold level. If a YES answer is obtained meaning that the state of charge of the battery 92 is higher than the threshold level, then the routine proceeds to step S230. Alternatively, if a NO answer is obtained, then the routine proceeds to step S240.

In step S230, the vehicle inside view monitor ECU 100 analyzes the parameters detected by the vehicle exterior sensors 70 to derive information about detection of a person(s) existing around the vehicle Va. The routine proceeds to step S250 wherein the vehicle inside view monitor ECU 100 analyzes the information derived in step S230 to determine whether there is a person around the vehicle Va. If a YES answer is obtained meaning that there is a person around the vehicle Va, then the routine proceeds to step S260. Alternatively, if a NO answer is obtained meaning that there is no person around the vehicle Va, then the routine proceeds to step S270.

In step S260, the vehicle inside view monitor ECU 100 determines whether the person detected around the vehicle Va meets the above-described deselection condition where it is unnecessary to pay attention to or watch a person. If a YES answer is obtained meaning the deselection condition is met, then the routine proceeds to step S270. Alternatively, if a NO answer is obtained, then the routine proceeds to step S280.

In step S270, the vehicle inside view monitor ECU 100 actuates the air-conditioner unit 21 and also actuates the power window motors 31 to fully open all the side windows of the vehicle Va. The routine then proceeds to step S290 wherein the vehicle inside view monitor ECU 100 starts to perform a near-person monitoring task, as will be described later, and then terminates the routine.

In step S280, the vehicle inside view monitor ECU 100 actuates the air-conditioner unit 21 and also actuates the power window motors 31 to open one(s) of the side windows far away from the living object P only by, for example, 1 cm. The vehicle inside view monitor ECU 100 maintains one of the side windows closest to the living object P closed fully. The routine then proceeds to step S300 wherein the vehicle inside view monitor ECU 100 starts a person position monitoring task, as will be described later, and then terminates the routine.

In step S240, the vehicle inside view monitor ECU 100 requests the vehicle Vb parked around the vehicle Va to transfer electrical power to the vehicle Va in the wireless mode. The routine then proceeds to step S310 wherein the vehicle inside view monitor ECU 100 determines whether the reception of electrical power is expected to be performed in response to the request made in step S240. If a YES answer is obtained meaning that the reception of electrical power is expected to be performed, then the routine proceeds to step S230. Alternatively, if a NO answer is obtained, then the routine proceeds to step S320.

In step S320, the vehicle inside view monitor ECU 100 analyzes the parameters detected by the vehicle exterior sensors 70 to derive information of detection of a person around the vehicle Va. The routine then proceeds to step S330 wherein the vehicle inside view monitor ECU 100 analyzes the detected parameters to determine whether a person exists around the vehicle Va. If a YES answer is obtained meaning that a person is detected, then the routine proceeds to step S340. Alternatively, if a NO answer is obtained meaning that no person is detected, then the routine proceeds to step S340.

In step S340, the vehicle inside view monitor ECU 100 determines whether a person detected around the vehicle Va meets the above-described deselection condition wherein a person detected is allowed to be excluded from those which should be watched or monitored. If a YES answer is obtained meaning the detected person meets the deselection condition, then the routine proceeds to step S350. Alternatively, if a NO answer is obtained, then the routine proceeds to step S360.

In step S350, the vehicle inside view monitor ECU 100 actuates the power window motors 31 fully opens all the side windows. The routine then proceeds to step S370 wherein the vehicle inside view monitor ECU 100 starts performing the near-person monitoring task, as will be described later, and then terminates the routine.

In step S360, the vehicle inside view monitor ECU 100 actuates the power window motors 31 to open one of the side windows which is located far away from the current position of the living object P by, for example, 1 cm. The routine then proceeds to step S380. In step S360, the vehicle inside view monitor ECU 100 keeps one of the side windows closest to the current position of the living object P closed fully. In step S380, the vehicle inside view monitor ECU 100 starts performing the person position monitoring task, as will be described later in detail, and then terminates the program.

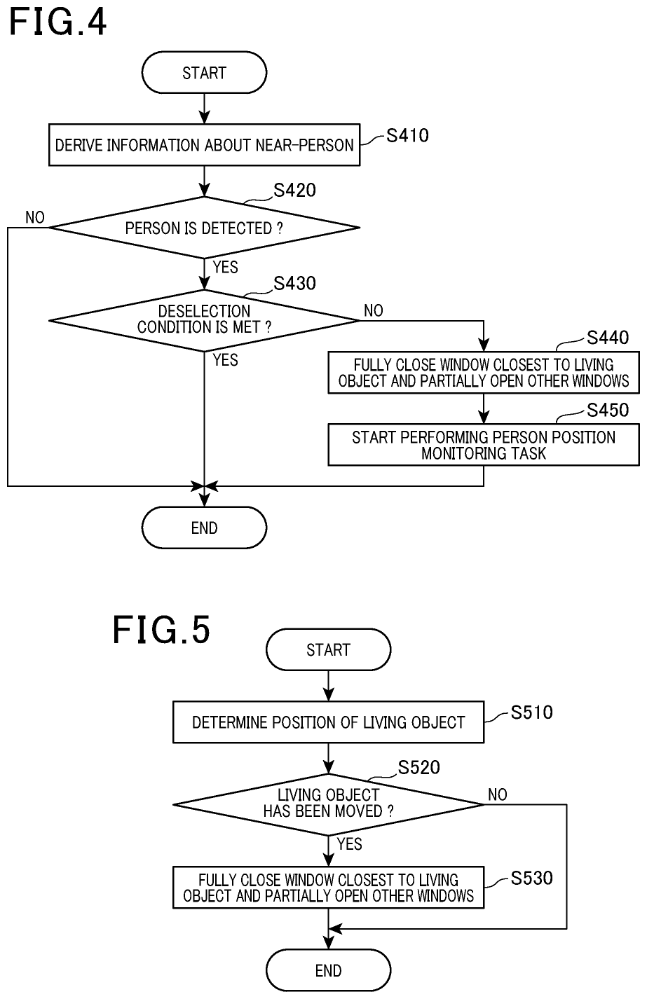

The vehicle inside view monitor ECU 100 performs the near-person monitoring task shown in FIG. 4. The routine proceeds to step S410 the vehicle inside view monitor ECU 100 analyzes the parameters detected by the vehicle exterior sensors 70 to obtain information about a person existing around the vehicle Va. The routine proceeds to step S420 wherein the vehicle inside view monitor ECU 100 analyzes the information derived in step S410 to determine whether a person is actually present around the vehicle Va. If a NO answer is obtained meaning that no person is detected, then the routine terminates.

Alternatively, if a YES answer is obtained in step S420, then the routine proceeds to step S430 wherein the vehicle inside view monitor ECU 100 determines whether the person detected around the vehicle Va meets the above-described deselection condition wherein a person detected is allowed to be excluded from those which should be watched or monitored. If a YES answer is obtained meaning the detected person meets the deselection condition, then the routine terminates. Alternatively, if a NO answer is obtained, then the routine proceeds to step S440.

In step S440, the vehicle inside view monitor ECU 100 actuates the power window motors 31 fully closes one of the side windows which is closest to the current position of the living object P and also opens the side window (s) farther away from the living object P by, for example, 1 cm. The routine proceeds to step S450 wherein the vehicle inside view monitor ECU 100 starts performing the person position monitoring task, as will be described later, and then terminates the routine. Note that the person monitoring task continues to be performed cyclically unless the person position monitoring task starts being performed.

The vehicle inside view monitor ECU 100 performs the person position monitoring task demonstrated in FIG. 5. First, in step S510, the vehicle inside view monitor ECU 100 analyzes the monitored in-vehicle condition information to determine the latest or current position of the living object P. The routine then proceeds to step S520.

In step S520, the vehicle inside view monitor ECU 100 determines whether the current position of the living object P has changed. If a YES answer is obtained meaning that the living object has moved, then the routine proceeds to step S530. Alternatively, if a NO answer is obtained, then the routine terminates.

In step S530, the vehicle inside view monitor ECU 100 actuates the power window motors 31 fully closes one of the side windows which is closest to the current position of the living object P and also opens the side window (s) farther away from the living object P by, for example, 1 cm. The routine then terminates. Note that the person position monitoring task continues to be performed cyclically as long as the vehicle Va is kept parked.

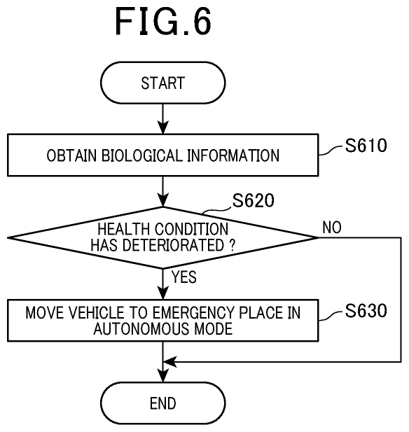

Upon initiation of the improvement strategies, the vehicle inside view monitor ECU 100 cyclically performs a health condition monitoring task in the way demonstrated in FIG. 6. First in step S610, the vehicle inside view monitor ECU 100 obtains the biological information about the living object P. The routine then proceeds to step S620 wherein the vehicle inside view monitor ECU 100 determines whether the health condition of the living object P has deteriorated. If a YES answer is obtained meaning that the health condition of the living object P has deteriorated, then the routine proceeds to step S630. Alternatively, if a NO answer is obtained, then the routine terminates.

In step S630. the vehicle inside view monitor ECU 100 instructs the self-driving control unit 50 installed in the vehicle Va to move the vehicle Va to the emergency place K, such as a hospital or a police station. The routine then terminates.

The above embodiment offers the following beneficial advantages.

1) When it is determined that the condition of the passenger compartment of the vehicle Va has deteriorated, the air-conditioner unit 21 that is the high-power improvement device is actuated to improve the condition of the passenger compartment unless the state of charge of the battery 92 is determined to have deteriorated, thereby resulting in a major improvement of the condition of the passenger compartment. When it is determined that the condition of the passenger compartment of the vehicle Va has deteriorated and that the state of charge of the battery 92 is lowered, only the power window motors 31 that is the low-power improvement device is actuated, thereby improving the condition of the passenger compartment with a decrease in the state of charge of the battery 92 being minimized. It is, therefore, possible to increase the condition of the passenger compartment as greatly as possible while minimizing the consumption of electrical energy stored in the battery 92.
2) When it is determined that the condition of the passenger compartment of the vehicle Va has deteriorated and that the state of charge of the battery 92 is determined to be lowered, but when the reception of electrical power is expected to be achieved in response to a request made by the power feeding requesting unit 150, the air-conditioner unit 21 is actuated, thereby greatly increasing the quality of condition of the passenger compartment while minimizing a risk that the state of charge of the battery 92 may decrease early.
3) When it is determined that the condition of the passenger compartment is determined to have deteriorated, the side window(s) of the vehicle Va is opened. Additionally, when a person is detected around the vehicle Va, the degree to which the side window(s) is opened is set smaller than when no person is detected around the vehicle Va. This minimizes a risk that the living object P or a non-living object an article occupying the passenger compartment may be damaged or harmed even when the side window(s) is opened.
4) When it is determined that the condition of the passenger compartment has deteriorated, and a person detected around the vehicle Va meets the deselection condition, the side window(s) is opened more greatly than when no persons which meet the deselected condition are detected. This eliminates a risk that the degree to which the side window(s) is opened may be undesirably set smaller than required when the person detected around the vehicle Va meets the deselection condition, that is, when there is a low probability that the living object P or a non-living object occupying the passenger compartment may be damaged or harmed. This improves the condition of the passenger compartment as greatly as possible.
5) When it is determined that the condition of the passenger compartment has deteriorated and that a person is detected near the vehicle Va, one of the side windows which is located closest to the current position of the living object P is opened to a degree smaller than the side window(s) farther away from the living object P. For instance, one of the side windows which is located closest to the living object P is fully closed. This minimizes a risk that the living object P in the passenger compartment may be injured.
6) When the monitored position of the living object P has changed, one of the side windows which is located closest to the current or latest position of the living object P is opened to a degree smaller than the side window (s) farther away from the living object P. For instance, one of the side windows which is located closest to the living object P is full closed. This minimizes a risk that the living object P in the passenger compartment may be injured even when the living object P has moved.
7) When the health condition of the living object P is determined to have deteriorated, the vehicle Va is moved to the emergency place K, such as a hospital or a police station, in the autonomous mode. This minimizes the deterioration of the health condition of the living object P.
8) When the living object P left in the passenger compartment is detected, at least one of the front window, the side windows, the rear windows, and the roof glass is set in the opaque state. This minimizes an undesirable rise in temperature of the passenger compartment which arises from, for example, sunlight. This also causes the living object P to become difficult to see from outside the vehicle Va, thus ensuring the security of the living object P.

### OTHER EMBODIMENTS

The processor used in the above embodiment includes one or a plurality of CPUs (Central Processing Units), but however, may be designed to have a GPU(s) (Graphics Processing unit(s)) or a DFP(s) (Data Flow Processor(s)) instead of the CPU. The processor may include an IP core designed to have built therein a FPGA (Field-Programmable Gate Array) and/or achieve a specific task, such as AI learning or AI inference. Such a processor may have arithmetic circuits which are separately mounted on a printed-circuit board or implemented by an ASIC (Application Specific Integrated Circuit) or an FPGA.

The high-power improvement device in the above embodiment is implemented by the air-conditioner unit 21. The low-power improvement device in the above embodiment is implemented by the power window motors 31. They may, however, be made by other devices as long as the high-power improvement device consumes a large amount of electrical 10) power, but is capable of making a large improvement of the condition of the passenger compartment, and the low-power improvement device is capable of improving the condition of the passenger compartment with a smaller consumption of electrical power than the high-power improvement device. For instance, the high-power improvement device may include the mist generator 22 and the seat air-conditioning system in addition to the air-conditioner unit 21. In such a case, when it is determined that the condition of the passenger compartment has deteriorated, the environment improvement unit 130 may 20) actuate the air-conditioner unit 21, the mist generator 22, and the seat air-conditioning system unless the state of charge of the battery 92 is determined to have reduced.

The environment improvement unit 130 in the above embodiment is designed to actuate or turn on the air-conditioner unit 21 and the power window motors 31 when the condition of the passenger compartment is determined to have deteriorated, and the state of charge of the battery 92 is determined not to have decreased undesirably, but however, may alternatively be configured in another way. For instance, when it is determined that the condition of the passenger compartment has deteriorated, and the state of charge of the battery 92 is kept high, the environment improvement unit 130 may actuate only the air-conditioner unit 21 without turning on the power window motors 31.

The vehicle Va in the above embodiment is implemented by an electrical vehicle equipped with an electrical motor used as a traction power source, but however, may alternatively be equipped only with an internal combustion engine or designed as a hybrid vehicle equipped with both an internal combustion engine and an electrical motor which are used as a traction power source. For instance, in a case where the vehicle Va is designed as an internal combustion engine vehicle not equipped with the power feeding requesting unit 150, the vehicle inside view monitor ECU 100 may work, when the state of charge of the battery 92 is determined to be lower than the threshold level in step S220, to proceed directly to step S320. Alternatively, in a case where the vehicle Va is designed as an internal combustion engine vehicle or a hybrid vehicle, the vehicle inside view monitor ECU 100 may work, when the state of charge of the battery 92 is determined to be lower than the threshold level during implementation of the improvement strategy, to start the internal combustion engine to charge the battery 92.

The environment improvement unit 130 in the above embodiment works, when the condition of the passenger compartment is determined to have deteriorated, to open the side windows. Additionally, when it is determined that the condition of the passenger compartment has deteriorated, and a person is detected around the vehicle Va, the environment improvement unit 130 opens the side windows to a degree smaller than when no persons are detected around the vehicle Va. Alternatively, the vehicle inside view monitor ECU 100 may be designed not to have the vehicle outside sensing unit 160. The environment improvement unit 130 may also be configured to determine the degree to which the side windows are opened regardless of whether a person is detected around the vehicle Va.

The environment improvement unit 130 in the above embodiment works, when a person detected around the vehicle Va meets the deselection condition, to open the side windows to a degree greater than when only a person(s) which does not meet the deselection condition is detected around the vehicle Va. The environment improvement unit 130 may alternatively be designed to determine the degree to which the side windows are opened regardless of whether a person which meets the deselection condition is detected around the vehicle Va.

The environment improvement unit 130 in the above embodiment works, when a person is detected around the vehicle Va, to set the degree to which one of the side windows which is located closest to the living object P is opened to be smaller than those of the side window (s) located farther away from the living object P, but however, may alternatively be designed to set the degree to which one of the side windows which is closest to the current position of the living object P is opened to be identical with those to which the other side windows are opened.

The environment improvement unit 130 in the above embodiment works, when it is determined that the condition of the passenger compartment has deteriorated, and a person is detected around the vehicle Va, to perform the improvement strategy and then monitor the current position of the living object P, but however, may alternatively be designed not to change the degree of opening of the side windows when the living object P has moved.

The environment improvement unit 130 in the above embodiment works, when the health condition of the living object P is found to have deteriorated after start of implementation of the improvement strategy, to perform the self-driving function of the vehicle Va to move the vehicle Va in the autonomous mode to the emergency place K, such as a hospital or a police station, but however, may alternatively be designed to, when the health condition of the living object P is found to have deteriorated after start of implementation of the improvement strategy, transmit an assistance request signal from the BLE communication module 82 to the mobile terminal M existing around the vehicle Va.

The environment improvement unit 130 in the above embodiment works, when the living object P which is left inside the passenger compartment is detected, to actuate the dimming glass device 3 to set the windows in the opaque state regardless of whether the condition of the passenger compartment has deteriorated, but however, the vehicle Va may be designed not to have the dimming glass device 3 installed therein. The environment improvement unit 130 may also be configured to, when the living object P left inside the passenger compartment is detected, keep the windows in the transparent state or change the windows from the opaque state to the transparent state.

The present disclosure has been described above on the basis of the embodiments, but may include various modifications or equivalents. The present disclosure may also include a combination of the elements described above or improvements without departing from the concept and the scope of the claims.

1-8. (canceled)

9. A vehicle inside view monitor which monitors an inside view of a passenger compartment of a vehicle which is parked, comprising:
a living object sensor which detects a living object remaining in the passenger compartment;
an environment determiner which, when the living object left in the passenger compartment is detected, determines whether a deterioration in condition of the passenger compartment unsuitable for the living object has occurred;
an environment improvement unit which, when the deterioration in condition of the passenger compartment is determined to have occurred, actuates at least one of a high-power improvement devie and a low-power improvement device mounted in the vehicle as one of improvement strategies for improving the condition of the passenger compartment; and
a state-of-charge determiner which determines whether a state of charge of a battery has decreased, wherein
when the deterioration of condition of the passenger compartment is determined to have occurred, the environment improvement unit works to actuate the high-power improvement device unless the state of charge of the battery is determined to have decreased and alternatively actuate only the low-power improvement device when the state of charge of the battery is determined to have decreased.

10. The vehicle inside view monitor as set forth in claim 9, further comprising a power feeding requesting unit which, when the deterioration of condition of the passenger compartment is determined to have occurred, and the state of charge of the battery is determined to have decreased, makes a request to a second vehicle parked around the vehicle for feeding electrical power to the vehicle in a wireless mode, and wherein
when it is determined that the condition of the passenger compartment has deteriorated and that the state of charge of the battery has decreased, the environment improvement unit actuates the high-power improvement device as long as reception of the electrical power is expected to be achieved in the vehicle in response to the request made by the power feeding requesting unit.

11. The vehicle inside view monitor as set forth in claim 9, further comprising a vehicle outside sensing unit which derives information about detection of a person existing around the vehicle, and wherein
the low-power improvement device includes a power window motor working to open or close a window of the vehicle,
when it is determined that the condition of the passenger compartment has deteriorated, the environment improvement unit opens the window,
when it is determined that the condition of the passenger compartment has deteriorated and that a person is detected around the vehicle, the environment improvement unit sets a degree to which the window is opened to be smaller than that when no person is detected around the vehicle.

12. The vehicle inside view monitor as set forth in claim 11, wherein the vehicle outside sensing unit determines whether a person detected around the vehicle meets a deselection condition wherein a person detected is allowed to be excluded from those which should be watched,
when it is determined that the condition of the passenger compartment has deteriorated and that a person detected around the vehicle meets the deselection condition, the environment improvement unit sets a degree to which the window is opened to be greater than when no person which meets the selected condition is only detected.

13. The vehicle inside view monitor as set forth claim 11, wherein the living object sensor works to determine a current position of the living object in the passenger compartment,
the window of the vehicle includes a plurality of windows,
when it is determined that the deterioration of condition of the passenger compartment has occurred and that a person is detected around the vehicle, the environment improvement unit sets a degree of opening of one of the windows which is located closest to the current position of the living object to be smaller than that of one of the windows which is located farther away from the current position of the living object.

14. The vehicle inside view monitor as set forth in claim 13, wherein when it is determined that the deterioration of condition of the passenger compartment has occurred and that a person is detected around the vehicle, the environment improvement unit monitors a current position of the living object,
when a position of the living object has changed, the environment improvement unit sets the degree of opening of one of the windows which is located closest to the changed position of the living object to be smaller than one of the windows which is located farther away from the changed position of the living object.

15. The vehicle inside view monitor as set forth in claim 9, wherein the environment determiner determines whether a health condition of the living object has deteriorated after start of implementation of the improvement strategy,
when it is determined that the health condition of the living object has deteriorated, the environment improvement unit performs a self-driving function installed in the vehicle to move the vehicle to an emergency place.

16. The vehicle inside view monitor as set forth in claim 9, further comprising a dimming glass device which switch a transparent state and an opaque state of a window mounted in the vehicle using an electrical signal, and wherein
when it is determined that the living object left in the passenger compartment is detected the environment improvement unit sets the window in the opaque state regardless of whether the deterioration of condition of the passenger compartment is determined to have occurred.
